(19) United States
(12) Patent Application Publication
(10) Pub. No.: US 2006/0219117 A1
(43) Pub. Date: Oct. 5, 2006

(54) Lithographic printing plate comprising support and imaging layer

(75) Inventors: Satoshi Hoshi, Shizuoka (JP); Kei Kikuchi, Shizuoka (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/390,070

(22) Filed: Mar. 28, 2006

(30) Foreign Application Priority Data
Mar. 29, 2005 (JP) 2005-095972

(51) Int. Cl. B41N 1/00

(52) U.S. Cl. 101/453

(57) ABSTRACT

A lithographic printing plate comprises a support and an imaging layer. The imaging layer consists of a hydrophilic area and a hydrophobic area. In printing, dampening water is attached on the hydrophilic area, while oily ink is attached on the hydrophobic area. The dampening water is attached on the hydrophilic area in an amount of 0.1 to 2 g/m².

### FIELD OF THE INVENTION

The present invention relates to a lithographic printing plate comprising a support and an imaging layer, which consists of a hydrophilic area on which dampening water is attached and a hydrophobic area on which oily ink is attached. The invention also relates to a presensitized lithographic plate comprising a support and a hydrophilic image-recording layer convertible into a hydrophobic layer. The invention further relates to a lithographic hydrophilic substrate comprising a support and a hydrophilic layer.

### BACKGROUND OF THE INVENTION

A conventional hydrophilic substrate of a lithographic printing plate has been an aluminum plate subjected to anodic oxidation. The anodically oxidized aluminum substrate is often treated with an undercoating agent (e.g., silicate, polyvinyl-sulfonic acid, polyvinylbenzoic acid) to form a more hydrophilic surface. Japanese Patent Provisional Publication No. 59(1984)-101651 discloses an undercoating (hydrophilic) layer made of a polymer having sulfonic acid groups.

A polymer film support (e.g., a polyethylene terephthalate film, a cellulose acetate film) has been proposed in place of a metal plate support (such as an aluminum plate support). The polymer film support requires a hydrophilic layer. Various hydrophilic layers have been proposed for the polymer film support. Examples of the known hydrophilic layers include a swollen hydrophilic layer made of a hydrophilic polymer and a hydrophobic polymer (described in Japanese Patent Provisional Publication No. 8(1996)-292558), a hydrophilic swollen layer made from a hydrophilic polymer and a cross-linking agent (described in Japanese Patent Provisional Publication No. 9(1997)-218507), and a hydrophilic layer made of a hydrophilic polymer hardened with hydrolyzed tetraalkyl orthosilicate (described in Japanese Patent Provisional Publication Nos. 8(1996)-272087 and 8(1996)-507727). Further, European Patent No. 0,709,228 discloses a polyethylene terephthalate support having micro-porous surface of hydrophilic cross-linked silicate.

### SUMMARY OF THE INVENTION

A conventional lithographic printing plate having a known hydrophilic layer can give a printed matter without causing unfavorable stain at the beginning of a printing process. However, a lithographic printing plate is required to have a more hydrophilic layer to give a printed matter without causing unfavorable stain even under severe conditions.

An object of the present invention is to provide a lithographic printing plate capable of giving printed matters without unfavorable stain even under severe conditions.

The present invention provides a lithographic printing plate which comprises a support and an imaging layer consisting of a hydrophilic area on which dampening water is attached and a hydrophobic area on which oily ink is attached, wherein the dampening water is attached on the hydrophilic area in an amount of 0.1 to 2 g/m².

The imaging layer is preferably provided on the support in an amount of 0.1 to 10 g/m².

The imaging layer preferably absorbs and retains the dampening water in an amount of 0.01 to 2 g/m².

The imaging layer can comprise a hydrophilic layer and a hydrophobic layer imagewise formed on the hydrophilic layer.

The imaging layer can also be formed by imagewise converting a hydrophilic layer into a hydrophobic layer.

The imaging layer can contain a cross-linked hydrophilic polymer formed by reaction of a hydrophilic polymer with a cross-linking agent. The cross-linking reactive agent has cross-linking groups in an amount of 10 to 100 mole % based on cross-linking reactive groups contained in said hydrophilic polymer.

The imaging layer can contain a cross-linked hydrophilic polymer formed by reaction of cross-linkable hydrophilic polymers having cross-linking groups. The cross-linking groups remain in the cross-linked polymer in an amount of 0 to 80 mole %.

The imaging layer can contain a graft-copolymerized hydrophilic polymer.

The imaging layer can contain particle filler in an amount of 5 to 70 wt. % based on the solid content of the imaging layer.

The invention also provides a presensitized lithographic plate comprising a support and a hydrophilic image-recording layer convertible into a hydrophobic layer, wherein the hydrophilic image-recording layer has a function of absorbing and retaining water in an amount of 0.01 to 2 g/m².

The invention further provides a lithographic hydrophilic substrate comprising a support and a hydrophilic layer, wherein the hydrophilic layer has a function of absorbing and retaining water in an amount of 0.01 to 2 g/m².

The invention furthermore provides a lithographic printing method comprising the steps of: subjecting a presensitized lithographic plate comprising a support and a hydrophilic image-recording layer to a process of imagewise converting the hydrophilic image-recording layer into a hydrophobic layer to form a lithographic printing plate which comprises an imaging layer having a hydrophilic area and a hydrophobic area; and then printing with the lithographic printing plate while supplying dampening water and oily ink to the plate under the condition that the dampening water is attached on the hydrophilic area in an amount of 0.1 to 2 g/m² and that the oily ink is attached on the hydrophobic area.

The invention still further provides a lithographic printing method comprising the steps of: subjecting a presensitized lithographic plate comprising a hydrophilic substrate and a an image-recording layer, said substrate comprising a support and a hydrophilic layer to a process of imagewise removing the image-recording layer to form a lithographic printing plate which comprises a hydrophilic area corresponding to the exposed hydrophilic layer and a hydrophobic area corresponding to the remaining image-recording layer; and then printing with the lithographic printing plate while supplying dampening water and oily ink to the plate under the condition that the dampening water is attached on the hydrophilic area in an amount of 0.1 to 2 g/m² and the oily ink is attached on the hydrophobic area.

The invention still furthermore provides a lithographic printing method comprising the steps of: imagewise attaching a hydrophobic material onto a hydrophilic substrate comprising a support and a hydrophilic layer to form a lithographic printing plate which comprises a hydrophilic area where the hydrophobic material is not attached and a hydrophobic area where the hydrophobic material is attached; and then printing with the lithographic printing plate while supplying dampening water and oily ink to the plate under the condition that the dampening water is attached on the hydrophilic area in an amount of 0.1 to 2 g/m² and the oily ink is attached on the hydrophobic area.

A lithographic printing method is essentially based on a difference between a hydrophilic surface on a non-imaging area and a hydrophobic surface on an imaging area. Therefore, it has been thought that a good printed matter can be obtained only if the hydrophilic layer is made more hydrophilic.

However, the applicant has studied and found that, even if the hydrophilic layer is made more hydrophilic in the conventional manner, good printed matters are not necessarily obtained. As described above, in order to enhance hydrophilicity of the hydrophilic layer, the hydrophilic layer is conventionally made swollen or porous. The thus-treated hydrophilic layer absorbs and retains therein much dampening water, and accordingly the dampening water stays too little on the surface of the hydrophilic layer to give good printed matters. In other words, it is revealed that quality of the printed matters depends on the amount of dampening water attached on the hydrophilic area (and the amount of damping water absorbable and retainable in the hydrophilic layer) during the printing procedure.

The applicant has further studied and found that the amount of dampening water attached on the hydrophilic area has a close relation to unfavorable stain. It is also found that the amount of attached dampening water can be estimated by subtracting the amount of water absorbable and retainable in the hydrophilic area from the total amount of water present in that area during the printing procedure. Particularly under severe conditions (for example, in the case where the amount of dampening water is restricted, where the printing procedure is immediately started with a printing plate having been so left installed in a press that the surface of the plate is completely dried, or where the image to be printed has such a dot-shadowed or thin line-framed area that the corresponding hydrophilic area is relatively small), quality of the printed image greatly depends on the amount of dampening water attached on the hydrophilic area. The applicant made experiments on the dampening water attached on the hydrophilic area, and finally found that the dampening water staying on the hydrophilic area is preferably in an amount of 0.1 to 2 g/m².

In a conventional presensitized lithographic plate, the hydrophilic layer absorbs and retains therein the dampening water so much that the dampening water staying on the hydrophilic area is in an amount out of the above range during the printing procedure. As a matter of course, if excess dampening water (in an amount much more than the amount absorbable in the hydrophilic layer) is supplied, even in a conventional presensitized plate, the dampening water attached on the hydrophilic area can be in an amount of the above range (0.1 to 2 g/m²). However, if such excess dampening water is supplied, oily ink cannot be attached on the hydrophobic area and hence it is impossible to print with that plate.

The applicant has furthermore studied and found that it is more favorable to make the hydrophilic layer hardly absorb water than to make the layer more hydrophilic. For example, the presensitized plate preferably has a hydrophilic layer cross-linked enough not to be swollen. Even if only a small amount of dampening water is supplied, such hydrophilic layer absorbs the dampening water so little that the dampening water can stay on the surface sufficiently. On the basis of this study, the applicant has achieved the present invention, in which the dampening water attached on the hydrophilic area is controlled in an amount of 0.1 to 2 g/m². According to the invention, good printed matters can be obtained without unfavorable stain even under severe conditions.

### DETAILED DESCRIPTION OF THE INVENTION

[Amount of Dampening Water Attached on Hydrophilic Area]

In the invention, during the printing procedure, the dampening water attached on the hydrophilic area is controlled in an amount of 0.1 to 2 g/m². The amount is preferably in the range of 0.1 to 1.5 g/m², and more preferably in the range of 0.1 to 1 g/m². For determining that amount, the amount (A) of water absorbed in the hydrophilic area (non-imaging area) and the total amount (B) of water kept in that area during the printing the difference can be regarded as the amount of dampening water attached on the hydrophilic area. Since this method is easier than the direct measurement, the amount of the attached water is preferably determined in this manner.

[Hydrophilic Layer]

The hydrophilic layer is improved to control the amount of dampening water staying on the hydrophilic area. The amount of dampening water absorbed and retained in the hydrophilic area is preferably in the range of 0.01 to 2 g/m², more preferably in the range of 0.01 to 1.5 g/m², most preferably in the range of 0.01 to 1 g/m². Accordingly, the hydrophilic layer absorbs water preferably in an amount of 0.01 to 2 g/m². The amount of the hydrophilic layer itself is preferably in the range of 0.1 to 10 g/m².

There are two embodiments of the hydrophilic layer. One is a hydrophilic image-recording layer convertible into a hydrophobic layer, and the other is a hydrophilic substrate comprising a support and a hydrophilic layer.

The hydrophilic image-recording layer is processed with an agent capable of converting hydrophilic properties into hydrophobic properties, to prepare a printing plate.

The hydrophilic substrate is processed to provide an image-recording layer on the hydrophilic layer or otherwise to form a hydrophobic area directly on the hydrophilic layer (for example, by ink-jetting hydrophobic oil-drops imagewise onto the hydrophilic layer), and thereby to prepare a printing plate.

The present invention can be applied to both embodiments.

In order to increase the amount of dampening water attached on the hydrophilic area, the hydrophilic layer is preferably made to absorb water little. Examples of the method to make the layer hardly absorb water include:

(1) a method in which the hydrophilic polymer constituting the layer is densely cross-linked,

(2) a method in which a hydrophilic layer having glass-like properties is formed according to sol-gel conversion, and

(3) a method in which the hydrophilic polymer constituting the layer is graft-copolymerized.

In combination with one of the above methods (1) to (3), an auxiliary method (4) in which particle filler is added to the layer can be adopted.

(Method using Densely Cross-Linked Hydrophilic Polymer)

The hydrophilic polymer before cross-linked is a known hydrophilic polymer.

As the hydrophilic polymer, synthetic polymers are preferred to natural polymers (e.g., polysaccharides, proteins) and semi-synthetic polymers (e.g., starch derivatives, cellulose ethers, cellulose esters). Examples of the polysaccharides include gum arabi, sodium alginate, hyaluronic acid and dextrin. Examples of the proteins include casein and gelatin. Examples of the cellulose ethers include carboxymethyl cellulose and sodium salt thereof, and hydroxyethyl cellulose. Examples of the cellulose esters include cellulose acetate.

The hydrophilic polymer preferably has a main chain of hydrocarbon, halogenated hydrocarbon, polyester, polyamide (e.g., alcohol-soluble nylon), polyamine, polyether (e.g., polyether derived from polyoxyethylene, 2,2-bis(4-hydroxyphenyl)propane and epichlorohydrin), polyurethane, polyurea or a combination thereof. The main chain is more preferably hydrocarbon, polyether, polyurethane, polyurea or a combination thereof. Most preferred is a main chain of hydrocarbon.

The hydrophilic polymer has hydrophilic groups preferably at the side chain or at the main chain. The hydrophilic groups may be substituent groups at the side chain. Examples of the hydrophilic groups include carboxylic groups, amino groups, phosphoric groups, sulfonic groups, hydroxyl, amide groups and polyoxyalkylene groups (e.g., polyoxyethylene). Preferred are carboxylic groups, amino groups, sulfonic groups, hydroxyl, amide groups and polyoxyalkylene groups.

The carboxylic groups, the phosphoric groups and the sulfonic groups may be in the form of anion or salt. Preferred counter ions of carboxylic groups are ammonium ions and alkali metal ions. Preferred counter ions of sulfonic groups are ammonium ions, alkali metal ions and alkaline earth metal ions.

The amino groups may be in the form of cation (ammonium ion) or salt. Preferred counter ions of amino groups are halide ions.

The hydrophilic polymer is preferably a polymer of ethylenically unsaturated monomer having a hydrophilic group. Examples of the ethylenically unsaturated monomer having a hydrophilic group include (meth)acrylic acid and salts thereof, itaconic acid and salts thereof, maleic acid and salts thereof, 2-hydroxyethyl (meth)acrylate, hydroxypropyl (meth)acrylate, hydroxybutyl (meth)acrylate, (meth)acrylamide, N-monomethylol(meth)acrylamide, N,N-dimethylol(meth)acrylamide, 3-vinylpropionic acid and salts thereof, vinylsulfonic acid and salts thereof, 2-sulfoethyl (meth)acrylate and salts thereof, polyoxyethylene glycol mono(meth)acrylate, 2-acrylamide-2-monopropanesulfonic acid and salts thereof, phosphooxypolyoxyethylene glycol mono(meth)acrylate and salts thereof, allylamine, and hydroxypropylene. Further, polyvinyl alcohol, polyvinyl formal, polyvinyl butyral and polyvinyl pyrrolidone are also polymers derived from ethylenically unsaturated monomers having hydrophilic groups. The saponification degree of polyvinyl alcohol is preferably 60 wt. % or more, more preferably 80 wt. % or more.

The hydrophilic polymer can be a homopolymer of ethylenically unsaturated monomer having a hydrophilic group, a copolymer of ethylenically unsaturated monomer having two or more kinds of hydrophilic groups, or a copolymer of ethylenically unsaturated monomer having a hydrophilic group and other ethylenically unsaturated monomers (having no hydrophilic group).

Examples of the ethylenically unsaturated monomers having no hydrophilic group include vinyl acetate and styrene. Examples of the copolymer include vinyl acetatemaleic acid copolymer and styrene-maleic acid copolymer.

Two or more hydrophilic polymers can be used in combination.

The hydrophilic polymer can be cross-linked by the method (1-1) in which cross-linkable groups are introduced into the polymer and made to react or by the method (1-2) in which the hydrophilic groups in the polymer are made to react with a cross-linking agent.

In the method (1-1), first the polymer is made to react with a compound having both a cross-linkable group and a group reactive with the hydrophilic group in the polymer. The cross-linkable group is preferably an ethylenically unsaturated group (e.g., vinyl, allyl, acryloyl, methacryloyl) or a ring-forming group (e.g., cinnamoyl, cinnamylidene, cyanocinnamylidene, p-phenylene diacrylate). The thus-treated polymer having the introduced cross-linkable groups are then cross-linked preferably with monomers having functional groups (similar to the cross-linking groups) reactive with the cross-linkable groups. In the cross-linking reaction, a polymerization initiator (described later) is preferably used. The introduced ethylenically unsaturated groups or the ring-forming groups are made to react preferably after or simultaneously with drying the hydrophilic layer having been formed on a support by coating procedure.

In the method (1-2), the hydrophilic groups in the polymer are made to react with a cross-linking agent having two or more functional groups reactive with the hydrophilic groups.

The cross-linking agent is generally a compound capable of forming cross-linking structure in a polymer when exposed to heat or light. The cross-linking agent is described in “Handbook of cross-linking agent (written in Japanese)”, S. Yamashita and T. Kaneko, Taiseikan Publisher Co., Ltd. (1981).

Examples of the reactive groups in the cross-linking agent include carboxyl and salts thereof, carboxylic anhydride, amino, imino, hydroxyl, epoxy, aldehyde, methylol, mercapto, isocyanate, block isocyanate group, alkoxysilyl, ethylenically unsaturated double bond, coordination bond, ester bond and tetrazole group.

Examples of the cross-linking agent having carboxyl as the reactive group include α,ω-alkanedicarboxylic acids (e.g., succinic acid, adipic acid), α,ω-alkenedicarboxylic acids, and polycarboxylic acids (e.g., 1,2,3-propanetricarboxylic acid, 1,2,3,4-butanetetracarboxylic acid, trimellitic acid, polyacrylic acid).

Examples of the cross-linking agent having amino or imino as the reactive group include amines (e.g., butylamine, spermine, diaminocyclohexane, piperazine, aniline, phenylenediamine, 1,2-ethanediamine, diethylenediamine, diethylenetriamine) and imines (e.g., polyethyleneimine).

Examples of the cross-linking agent having epoxy as the reactive group include polyepoxy compounds (e.g., ethylene glycol diglycidyl ether, propylene glycol diglycidyl ether, tetraethylene glycol diglycidyl ether, nonaethylene glycol diglycidyl ether, polyethylene glycol glycidyl ether, propylene glycol glycidyl ether, neopentyl glycol diglycidyl ether, 1,6-hexanediol diglycidyl ether, trimetylolpropane triglycidyl ether, sorbitol polyglycidyl ether).

Examples of the cross-linking agent having hydroxyl as the reactive group include alkylene glycols (e.g., ethylene glycol, propylene glycol), oligoalkylene glycols (e.g., diethylene glycol, tetraethylene glycol), polyalkylene glycols, polyols (e.g., trimethylolpropane, glycerol, pentaerythritol, sorbitol, polyvinyl alcohol).

Examples of the cross-linking agent having aldehyde as the reactive group include polyaldehydes (e.g., glyoxal, terephthalaldehyde).

Examples of the cross-linking agent having isocyanate or block isocyanate group as the reactive group include polyisocyanates (e.g., tolylenediisocyanate, hexamethylenediisocyanate, diphenylenemethaneisocyanate, xylenediisocyanate, polymethylenepolyphenylisocyanate, cyclohexyldiisocyanate, cyclohexanephenylenediisocyanate, naphthalene-1,5-diisocyanate, isopropylbenzene-2,4-diisocyanate, adduct of polypropylene glycol/tolylene-diisocyanate) and block polyisocyanate compounds.

Examples of the cross-linking agent having alkoxysilyl as the reactive group include silane-coupling agents (e.g., tetraalkoxysilane).

Examples of the cross-linking agent having coordination bond as the reactive group include metal cross-linking agents (e.g., acetylacetonatoalumium, acetylacetonatocopper, acetylacetonatoiron (III)).

Examples of the cross-linking agent having methylol as the reactive group include polymethylol compounds (e.g., trimethylolmelamine, pentaerythritol).

Examples of the cross-linking agent having mercapto as the reactive group include polythiol compounds (e.g., dithioerythritol, pentaerythritol tetrakis(2-mercaptoacetate) and trimethylolpropane tris(2-mercaptoacetate)).

For cross-linking densely, the cross-linking agent has cross-linking groups preferably in an amount of 10 to 100%, more preferably in an amount of 20 to 100%, and most preferably in an amount of 30 to 100% based on the amount (mol) of cross-linkable groups in the hydrophilic polymer.

The cross-linking degree of the polymer can be evaluated in terms of the amount of reacted (or remaining) cross-linkable groups in the hydrophilic polymer. The amount of reacted cross-linkable groups is preferably in the range of 10 to 100%, more preferably in the range of 20 to 100%, most preferably in the range of 30 to 100%. The cross-linkable groups can be quantified by means of H-NMR or FT-IR.

(Method using Glass-Like Hydrophilic Layer)

In the case where a hydrophilic layer having glass-like properties is formed according to sol-gel conversion, the hydrophilic polymer is prepared preferably from metal hydroxide and metal oxide, more preferably from sol-gel conversion system forming polysiloxane gel. The sol-gel conversion system is described in Japanese Patent Provisional Publication No. 2003-175683.

The sol-gel conversion system is a polymer having resin structure. In the system, multivalent atoms are combined with bonding groups via oxygen atoms to form a network structure. At the same time, the multivalent atoms also have free hydroxyls and free alkoxy groups. Before spread to form the layer, the system is in the form of sol since hydroxyls and alkoxy groups are still free. When once the system is spread, according as the esterification proceeds, the network resin structure is so firmly formed that the system becomes in the form of gel.

Examples of the multivalent atoms in the sol-gel conversion system include atoms of aluminum, silicon, titanium, and zirconium. Most preferred is silicon, namely, a sol-gel conversion system having siloxane bonds.

Examples of the silane compound used in the sol-gel conversion system include tetrachlorosilane, tetrabromosilane, tetramethoxysilane, tetraethoxysilane, tetraisopropoxysilane, tetrabutoxysilane, dimethoxydiethoxysilane, triethoxysilane, tribromosilane, trimethoxysilane, isopropoxysilane, and tri(t-butoxy)silane.

In combination with the silane compound, other metal compounds (e.g., compounds of Ti, Zn, Sn, Zr and Al) can be used. Examples of the metal compounds include Ti(OR)₄, TiCl₄, Zn(OR)₂, Zn(CH₃COCHCOCH₃)₂, Sn(OR)₄₁ Sn(CH₃COCHCOCH₃)₄, Sn(OCOR)₄, SnCl₄, Zr(OR)₄, Zr(CH₃COCHCOCH₃)₄ and Al(OR)₃ in which R is an alkyl group having 1 to 6 carbon atoms.

The cross-linking agent or the following hydrophilic polymer, in which a functional group corresponding to a silane-coupling agent is positioned at the terminal, can be added to the matrix having gel structure. The hydrophilic polymer having the functional group at the terminal (disclosed in Japanese Patent Provisional Publication No. 2003-175683) is represented by the formula:
(R—)ₘ(RO—)₃₋ₘSi—(CH₂)ₙ—S—(CHR—CR(-L-Y)ₚ—
in which R is hydrogen atom or a hydrocarbon group having 1 to 8 carbon atoms; m is 0, 1 or 2; n is an integer of 1 to 8; p is an integer of 30 to 300; L is a single bond or a divalent linking group; Y is —NHCOCH₃, —CONH₂, —CON(CH₃)₂, —COCH₃, —OCH₃, —OH, —CO₂M or —CONHC(CH₃)₂SO₃M; and M is a counter ion selected from the group consisting of proton, an alkali metal ion, an alkaline earth metal ion and an onium ion. The divalent linking group preferably comprises 1 to 60 carbon atoms, 0 to 10 nitrogen atoms, 0 to 50 oxygen atoms, 1 to 100 hydrogen atoms and 0 to 20 sulfur atoms.

In the above description, silicon can be replaced with aluminum, titanium or zirconium.

The layer having glass-like properties has a glass-like structure, in which the multivalent atoms are densely combined with bonding groups via oxygen atoms to form a firm network structure. The sol-gel conversion system before spread contains many free alkoxy groups, which are then hydrolyzed into hydroxyls. According as the reaction further proceeds, the hydroxyls become dehydrated to condense. Consequently, in the resultant glass-like structure, hydroxyls remain in a small amount. The amount of remaining hydroxyls can be measured by means of H-NMR or FT-IR, and is preferably in the range of 0 to 80%, more preferably in the range of 0 to 70%, and most preferably in the range of 0 to 50%.

(Method using Graft-Copolymerized Hydrophilic Polymer)

The hydrophilic polymer used in the titled method has a reactive group at only one of the terminals of the main chain or of the side chain, preferably, of the main chain. The term “reactive group” means a functional group capable of reacting with a chemical bond-forming agent to form a chemical bond, and hence is a relative concept depending on reactivity with the bond-forming agent. The hydrophilic polymer is water-soluble, but preferably becomes water-insoluble when once the polymer reacts with the bond-forming agent.

Examples of the chemical bond include covalent bond, ionic bond, coordinate bond and hydrogen bond. Covalent bond is preferred.

The reactive group is normally the same as that included in the chemical bond-forming agent. The aforementioned description for the cross-linking agent is also applied to the chemical bond-forming agent.

Examples of the reactive group include carboxyl (i.e., HOOC—) and salts thereof (i.e., MOOC— in which M is a cation), carboxylic anhydride groups (for example, monovalent groups derived from succinic anhydride, phthalic anhydride and maleic anhydride), amino (i.e., H₂N—), hydroxyl (i.e., HO—), epoxy group (e.g., 1,2-epoxyethyl), methylol (i.e., HO—CH₂—), mercapto (i.e., HS—), isocyanate (i.e., OCN—), block isocyanate group, alkoxysilyl, ethylenically unsaturated double bond, ester bond and tetrazole group. The hydrophilic polymer can have two or more reactive groups at one of the terminals, and the plural reactive groups may be the same or different from each other.

The hydrophilic polymer preferably has a linking group between the reactive group and the terminal repeating unit. Examples of the linking group include —O—, —S—, —CO—, —NH—, —N<, aliphatic groups, aromatic groups, heterocyclic groups and combinations thereof. The linking group is preferably —O—, —S— or a combination containing —O— or —S—. Preferably, the linking group of —O— or —S— combines with the terminal repeating unit of the hydrophilic polymer.

The aforementioned manner for cross-linking the hydrophilic polymer densely is also applied to the main chain and the hydrophilic group in the hydrophilic polymer of this method.

There may be another linking group between the main chain and the hydrophilic group in the hydrophilic polymer. The linking group is preferably selected from the group consisting of —O—, —S—, —CO—, —NH—, —N<, aliphatic groups, aromatic groups, heterocyclic groups and combinations thereof.

The hydrophilic polymer having a reactive group at only one of the terminals can be, for example, synthesized through radical polymerization of hydrophilic monomer (e.g., acrylamide, acrylic acid, potassium 3-sulfopropyl methacrylate) in the presence of a chain transfer agent (described in “Handbook of radical polymerization (written in Japanese)”, NTS, by K. Kamachi and T. Endo) or Iniferter (described in Macromolecules 1986, 19, pp. 287 (Otsu)). Examples of the chain transfer agent include 3-mercaptopropionic acid, 2-aminoethanethiolhydrochloric salt, 3-mercaptopropanol and 2-hydroxyethylsulfide. It is also possible to use not the chain transfer agent but a radical polymerization initiator having the reactive group (e.g., carboxyl) so that the hydrophilic monomer (e.g., acrylamide) can be radical-polymerized.

The hydrophilic polymer having a reactive group at only one of the terminals has a weight average molecular weight of 1,000,000 or less, preferably 1,000 to 1,000,000, more preferably 10,000 to 70,000.

In the case where the reactive group positioned at one of the terminals is carboxyl or a salt thereof, the chemical bond-forming agent is preferably a polyepoxy compound, a polyamine compound, a polymethylol compound, a polyisocyanate compound, a block polyisocyanate compound or a metal cross-linking agent.

In the case where the reactive group at the terminal is methylol, phenolic hydroxyl or glycidyl, the chemical bond-forming agent is preferably a polycarboxylic compound, a polyamine compounds or a polyhydroxy compound.

In the case where the reactive group at the terminal is amino, the chemical bond-forming agent can be a polyisocyanate compound, a block polyisocyanate compound, a polyepoxy compound or a polymethylol compound.

In the case where the reactive group at the terminal is hydroxyl, the chemical bond-forming agent can be a polyisocyanate compound, a block polyisocyanate compound, a polyaldehyde compound or a polycarboxylic compound.

In the case where the reactive group at the terminal is an alkoxysilyl group, the chemical bond-forming agent can be a tetraalkoxysilane or a polyhydric alcohol.

In the case where the reactive group at the terminal is an ethylenically unsaturated double bond, the chemical bond-forming agent can be a polythiol compound, an amine or an imine.

Besides the reaction between the hydrophilic polymer and the bond-forming agent described above, reactions among epoxy groups in molecules of the bond-forming agent can be also used.

The reactive group at one of the terminals in the hydrophilic polymer reacts with a reactive group of the bond-forming agent, so that two reactive groups in the bond-forming agent can be chemically combined.

The reactive group at the terminal in the hydrophilic polymer can react with a reactive group of the bond-forming agent A, and another reactive group of the agent A can react with a reactive group of another bond-forming agent B. As a result, two reactive groups in the bond-forming agent B can be chemically combined. The agent B may be further react with the reactive group of the hydrophilic polymer.

In the resultant structure, one terminal of the hydrophilic polymer is fixed while the hydrophilic parts (consisting of hydrophilic repeating units other than the fixed terminal) of the polymer are free and good in mobility.

(Method Adding Particle Filler to Hydrophilic Layer)

Particles as filler can be added to the hydrophilic layer so as to prevent the layer from absorbing and retaining water, to roughen the surface of the layer and to increase the dampening water staying on the surface. Further, the particles reinforce the hydrophilic layer.

As the filler, either organic or inorganic particles can be used.

The organic particles are preferably made of polymers, which are more preferably cross-linked. The organic particles can have core/shell structures (including microcapsules). The organic particles preferably have hydrophilic surfaces. In detail, the particles preferably have surfaces hydrophilic enough to disperse in water.

The organic particles can be prepared according to the emulsion polymerization method. For example, the microgel disclosed in Japanese Patent Provisional Publication No. 5(1993)-254251 can be obtained by emulsion polymerization. In the emulsion polymerization method, a monomer is emulsified and polymerized with an emulsifier having at least one functional group having a carbon-carbon double bond, preferably two or more carbon-carbon double bond-having functional groups.

Examples of the monomer include alkyl acrylates, alkyl acrylates, styrene and derivatives thereof. Examples of the carbon-carbon double bond-having functional groups include vinyl, allyl, 1-propenyl, 2-methyl-1-propenyl, isopropenyl, acryloyl and methacryloyl. Preferred are acryloyl and methacryloyl.

The emulsifier comprises a hydrophilic group as well as the carbon-carbon double bond. Examples of the hydrophilic group include carboxylic groups and salts thereof, sulfuric ester groups and salts thereof, amino, substituted amino groups, hydroxyl, phosphoric groups and salts thereof, and polyoxyalkylene groups (e.g., polyoxy-ethylene, polyoxypropylene). The counter ions of carboxylic groups, sulfuric ester groups and phosphoric groups are preferably alkali metal ions (e.g., ions of sodium and potassium). The substituent group of substituted amino group is preferably an alkyl group, an aralkyl group or a hydroxyalkyl group, more preferably an alkyl group or a hydroxyalkyl group. The hydrophilic group is preferably a substituted amino group.

The emulsifier comprising a carbon-carbon double bond works not only as a normal emulsifier but also as a polymerizable (cross-linkable) monomer. Accordingly, the above emulsifier can provide hydrophilic groups (originated from the emulsifier) on the surface of polymer fine particles. If the emulsifier, its amount and/or reactions are adequately selected, the hydrophilic groups can be also provided inside of the polymer fine particles.

Examples of the emulsifier include a sulfosuccinic ester salt of polyoxyethylenealkyl ether having two or more carbon-carbon double bonds in its molecular structure, a sulfuric ester salt of polyoxyethylenealkyl ether having two or more carbon-carbon double bonds in its molecular structure, a sulfosuccinic ester salt of polyoxyethylenealkylphenyl ether having two or more carbon-carbon double bonds in its molecular structure, a sulfuric ester salt of polyoxyethylenealkylphenyl ether having two or more carbon-carbon double bonds in its molecular structure, a dispersant of acidic phosphoric (meth)acrylic esters, a phosphoric ester of oligoester (meth)acrylate and alkaline salts thereof, and an oligoester poly(meth)acrylate of polyalkylene glycol having a hydrophilic alkyleneoxide group. Commercially available emulsifiers (e.g., KAYAMER PM-2 (Nippon Kayaku Co., Ltd.), New Frontier A-229E (Daiichi-Siyaku Co., Ltd.), New Frontier N-250Z (Daiichi-Siyaku Co., Ltd.)) are also usable.

The emulsifier comprising a carbon-carbon double bond can be used in combination with other emulsifiers (anionic surface active agents, cationic surface active agents, nonionic surface active agents). The amount of the emulsifier is preferably in the range of 1 to 20 weight parts, more preferably in the range of 3 to 10 weight parts based on 100 weight parts of the monomer.

The emulsion polymerization is, for example, carried out in the following manner. First, water and the emulsifier are placed on a reaction container, and then the monomer is added and mixed. After the mixture is emulsified, the radical polymerization initiator is added. The liquid is heated and stirred to polymerize the monomer and thereby to prepare polymer fine particles. The monomer can be added at a time, or otherwise can be separated into two or more portions and dropped. The amount of each component is preferably controlled so that the resultant reaction liquid (dispersion) can have a solid content of 20 to 50 wt. %, more preferably 30 to 45 wt. %. In the reaction, the pH value is preferably in the range of 3 to 9. The reaction temperature is preferably in the range of 40 to 90° C., more preferably in the range of 50 to 80° C. The reaction time is preferably in the range of 30 minutes to 2 hours.

The radical polymerization initiator is preferably a persulfuric salt (e.g., potassium persulfate, ammonium persulfate), hydrogen peroxide, an aqueous azo compound or a redox polymerization initiator. Particularly preferred is a redox polymerization initiator, which is generally a combination of a persulfuric salt and a reductant (e.g., sodium hydrogensulfite, sodium thiosulfate). The radical polymerization initiator is added preferably in an amount of 0.05 to 5 wt. %, more preferably in an amount of 0.1 to 3 wt. % based on the total amount of the monomer.

The polymerization reaction is preferably conducted in the presence of a polymerization accelerator (e.g., transition metal ions).

It is also possible to prepare organic fine particles from calcium alginate.

Examples of the inorganic fine particles include particles of silica, alumina, magnesium oxide, titanium oxide, magnesium carbonate, and mixtures thereof. As the inorganic fine particles, commercially available products (e.g., colloidal silica dispersion) are also uable.

The fine particles preferably have a mean diameter of preferably 5 nm to 10 μm, more preferably 0.5 μm to 3 μm.

The hydrophilic layer contains the fine particles preferably in an amount of 5 to 70%, more preferably in an amount of 10 to 60%, and most preferably in an amount of 15 to 50% based on the total amount of the solid content.

(Low Molecular Weight Hydrophilic Compound)

The hydrophilic layer can further contain a low molecular weight hydrophilic compound. Examples of the low molecular weight hydrophilic compound include glycols (e.g., ethylene glycol, diethylene glycol, triethylene glycol, propylene glycol, dipropylene glycol, tripropylene glycol), ethers and esters thereof, polyhydric alcohols (e.g., glycerol, pentaerythritol), amines (e.g., triethanolamine, diethanolamine, monoethanilamine) and salts thereof, sufonic acids (e.g., toluenesulfonic acid, benzenesulfonic acid) and salts thereof, phosphonic acids (e.g., phenylphosphonic acid) and salts thereof, and carboxylic acids (e.g., tartaric acid, oxalic acid, citric acid, malic acid, lactic acid, gluconic acid, amino acid) and salts thereof.

(Agent Capable of Converting Hydrophilic Properties into Hydrophobic Properties)

In the embodiment comprising a hydrophilic image-recording layer convertible into a hydrophobic layer, the image-recording layer contains an agent capable of converting hydrophilic properties into hydrophobic properties.

The converting agent is preferably a compound (preferably, a polymer) whose hydrophilic properties change into hydrophobic properties when exposed to heat or otherwise a hydrophobic compound in the form of thermo-plastic particles, thermosetting particles or microcapsules.

The above property-changing compound is preferably a polymer having functional groups that undergo decarboxylation to change hydrophilic properties into hydrophobic properties. That polymer is described in Japanese Patent Provisional Publication No. 2000-122272. If the property-changing compound is spread on a support to form a layer, the contact angle of a water drop on the layer is preferably 20° or less before heated but 65° or more after heated.

The hydrophobic compound in the form of thermoplastic particles or thermosetting particles is preferably a polymer. The polymer particles are, accordingly, preferably thermoplastic polymer particles, thermoreactive polymer particles or microcapsules containing the hydrophobic compound.

The thermoplastic polymer particles are described in Research Disclosure No. 33,303 (1992 January); Japanese Patent Provisional Publication Nos. 9(1997)-123387, 9(1997)-131850, 9(1997)-171249, 9(1997)-171250; and European Patent No. 931,647.

The thermoplastic polymer particles preferably have a mean size of 0.01 to 2.0 μm. The thermoplastic polymer particles can be prepared according to the emulsion polymerization method, the suspension polymerization method or the solution dispersion method. In the solution dispersion method, a monomer is dissolved in a non-aqueous organic solvent, and the solution is mixed and emulsified with an aqueous solution containing a dispersant. The thus-obtained emulsion is heated to evaporate the solvent, so that the polymer is solidified in the form of particles.

The thermoreactive polymer particles are thermosetting polymer particles or thermoreactive group-containing polymer particles.

Examples of the thermosetting polymer include resin having phenol skeleton, urea resin, melamine resin, alkyd resin, unsaturated polyester resin, polyurethane resin and epoxy resin. Preferred are resin having phenol skeleton, melamine resin, urea resin and epoxy resin.

The thermosetting polymer particles preferably have a mean size of 0.01 to 2.0 μm. The thermoplastic polymer particles can be prepared according to the solution dispersion method. The particles can be formed simultaneously with synthesis of the thermosetting polymer.

Examples of the thermoreactive group contained in the thermoreactive group-containing polymer particles include a radial polymerizable group (e.g., acryloyl, methacryloyl, vinyl, allyl), a cationic polymerizable group (e.g., vinyl, vinyloxy), an addition-reactive group (e.g., isocyanate, block isocyanate, epoxy, vinyloxy) and its counter active hydrogen-containing group (e.g., amino, hydroxyl, carboxyl), a condensation-reactive group (e.g., carboxyl) and its counter functional group (e.g., hydroxyl, amino), and a ring-opening addition-reactive group (e.g., acid anhydride) and its counter functional group (e.g., hydroxyl, amino).

The thermoreactive group can be introduced into the polymer particle simultaneously with polymerization for preparing the polymer.

For introducing the thermoreactive group in the polymerization, a monomer having the thermo-reactive group is preferably polymerized according to emulsion polymerization or suspension polymerization. Examples of the thermo-reactive group-containing monomer include allyl methacrylate, allyl acrylate, vinyl methacrylate, vinyl acrylate, 2-(vinyloxy)ethyl methacrylate, p-vinyloxystyrene, p-{2-(vinyloxy)ethyl}-styrene, glycidyl methacrylate, glycidyl acrylate, 2-isocyanateethyl methacrylate and block isocyanate thereof, 2-isocyanatoethyl acrylate and block isocyanate thereof, 2-aminoethyl methacrylate, 2-aminoethyl acrylate, 2-hydroxy-ethyl methacryalate, 2-hydroxyethyl acryalate, acrylic acid, methacrylic acid, maleic anhydride, di-functional acrylate and di-functional methacrylate. The above block isocyanates can be obtained, for example, by blocking with alcohols.

The thermoreactive group-containing monomer can be copolymerized with another monomer (having no thermo-reactive group). Examples of the monomer having no thermo-reactive group include styrene, an alkyl acrylate, an alkyl methacrylate, acrylonitrile and vinyl acetate.

In another way, the thermoreactive group can be introduced by a high-molecular reaction after preparation of the polymer. The high-molecular reaction is described in PCT Pamphlet No. 96/34316.

The thermoreactive group-containing polymer particles have a mean size of preferably 0.01 to 2.0 μm, more preferably 0.05 to 2.0 μm, most preferably 0.1 to 1.0 μm.

The microcapsules serving as the hydrophilic-hydrophobic properties converting agent contain a hydrophobic compound. The hydrophobic compound preferably has a thermoreactive group, which is the same as the above-described thermoreactive group of the polymer particle. The monomer having the thermoreactive group is, for example, the thermoreactive group-containing monomer above-described for the polymer particles or a monomer having plural ethylenically unsaturated groups. Examples of the monomer having plural ethylenically unsaturated groups include an acrylic aster of polyhydric alcohol (e.g., trimethylolpropane triacrylate, pentaerythritol tetraacrylate), a methacrylic aster of polyhydric alcohol (e.g., dipentaerythritol dimethacrylate), an itaconic aster of polyhydric alcohol (e.g., ethylene glycol diitaconate), a maleic aster of polyhydric alcohol (e.g., ethylene glycol dimaleate) and a polyhydric acrylamide (e.g., methylenebisacrylamide).

The microcapsules can be prepared according to known methods such as coacervation method (described in U.S. Pat. Nos. 2,800,457 and 2,800,458), interfacial polymerization method (described in British Patent No. 990,443, U.S. Pat. No. 3,287,154, Japanese Patent Publication Nos. 38(1963)-19574, 42(1967)-446 and 42(1967)-711), polymer deposition method (described in U.S. Pat. Nos. 3,418,250, 3,660,304), isocyanate-polyol wall formation method (described in U.S. Pat. No. 3,796,669), isocyanate wall formation method (described in U.S. Pat. No. 3,914,511), urea-formaldehyde or urea-formaldehyde-resorcinol wall formation method (described in U.S. Pat. Nos. 4,001,140, 4,087,376, 4,089,802), melamine-formaldehyde (described in U.S. Pat. No. 4,025,445) or hydroxycellulose wall form ation method, in situ method with monomer polymerization (described in Japanese Patent Publication Nos. 36(1961)-9163, 51(1976)-9079), spray-drying method (described in British Patent No. 930,422, U.S. Pat. No. 3,111,407) and electrolytic dispersion cooling method (described in British Patent Nos. 952,807 and 967,074).

As a dispersant for dispersing the microcapsules stably in an aqueous medium, water-soluble polymers can be used. Examples of the water-soluble polymers include natural polymers (e.g., polysaccharides, proteins), semi-synthetic polymers (e.g., cellulose ethers, starch derivatives) and synthetic polymers. Examples of the polysaccharides include gum arabi and sodium alginate. Examples of the proteins include casein and gelatin. Examples of the cellulose ethers include carboxymethyl cellulose and methyl cellulose. The synthetic polymer is preferably a polymer having a main chain of hydrocarbon (e.g., polyvinyl alcohol and derivatives thereof, polyacrylic amide and derivatives thereof, polyvinyl pyrrolidone). Further, a copolymer can be used. Examples of the copolymer include ethylene/vinyl acetate copolymer, styrene/maleic anhydride copolymer, ethylene/maleic anhydride copolymer, isobutylene/maleic anhydride copolymer, ethylene/acrylic acid copolymer and vinyl acetate/acrylic acid copolymer.

It is preferred for the water-soluble polymer not to react or to have little reactivity with the isocyanate compound. If a polymer having high reactivity with the isocyanate compound (for example, gelatin) is to be used, reactive functional groups in the polymer are preferably beforehand eliminated or blocked.

The wall of microcapsules is preferably three-dimensionally cross-linked, and can be preferably swelled with a solvent. For the purpose of that, the wall is preferably made of polyurea, polyurethane, polyester, polycarbonate, polyamide, or a mixture or copolymer thereof. Particularly preferred materials are polyurea, polyurethane and a mixture or copolymer thereof. A thermoreactive group-containing compound may be introduced into the microcapsule wall.

The microcapsules have a mean particle size of preferably. 0.01 to 3.0 μm, more preferably 0.05 to 2.0 μm, most preferably 0.10 to 1.0 μm.

The polymer particles or the microcapsules are contained in the hydrophilic image-recording layer in an amount of preferably 50 wt. % or more, more preferably 70 to 98 wt. %, in terms of solid content, based on the solid content of the image-recording layer.

In incorporating the microcapsules into the hydrophilic image-recording layer, a solvent both dissolving the content of capsule and swelling the wall of capsule may be added into dispersion of the microcapsules. Examples of the solvent include alcohols (e.g., methanol, ethanol, n-propanol, t-3butanol), ethers (e.g., tetrahydrofuran, propylene glycol monomethyl ether, ethylene glycol diethyl ether, ethylene glycol monomethyl ether), acetals, esters (e.g., methyl lactate, ethyl lactate, γ-butyl lactone), ketones (e.g., methyl ethyl ketone), polyhydric alcohols, amides (e.g., dimethylformamide, N,N-dimethylacetamide), amines and fatty acids. Two or more solvents may be used in combination.

The solvent is contained in the coating liquid in an amount of preferably 5 to 95 wt. %, more preferably 10 to 90 wt. %, most preferably 15 to 85 wt. %.

(Agent Capable of Converting Light to Heat)

In the embodiment comprising a hydrophilic image-recording layer convertible into a hydrophobic layer, the image-recording layer preferably contains an agent capable of converting light to heat.

The converting agent absorbs light, and converts the energy of light into thermal energy. The light is preferably infrared light, and accordingly the agent is preferably an IR absorber.

Accordingly, as the agent capable of converting light to heat, pigments, dyes and metal fine particles absorbing infrared light are preferably used. If the microcapsules are used, the converting agent is preferably an IR absorbing dye.

The IR absorbing dyes are described in “Handbook of Dyes (written in Japanese)”, 1970, edited by Association of Organic Synthetic Chemistry; “Chemical Industry (written in Japanese)”, May 1986, pp. 45-51, the article titled “Near IR Absorbing Dyes”; and “Development and Market of functional dyes in 1990”, 1990, Chapter 2, Sections 2 and 3, published by CMC. Examples of the preferred IR absorbing dye include azo dyes, metal complex salt azo dyes, pyrazolone azo dyes, naphthoquinone dyes (described in Japanese Patent Provisional Publication Nos. 58(1983)-112793, 58(1983)-224793, 59(1984)-48187, 59(1984)-73996, 60(1985)-52940 and 60(1985)-63744), anthraquinone dyes, phthalocyanine dyes (described in Japanese Patent Provisional Publication No. 11(1999)-235883), squarilium dyes (described in Japanese Patent Provisional Publication No. 58(1983)-112792), pyrylium dyes (U.S. Pat. Nos. 3,881,924, 4,283,475, Japanese Patent Provisional Publication Nos. 57(1982)-142645, 58(1983)-181051, 58(1983)-220143, 59(1984)-41363, 59(1984)-84248, 59(1984)-84249, 59(1984)-146063, 59(1984)-146061, Japanese Patent Publication Nos. 5(1993)-13514 and 5(1993)-19702), carbonium dyes, quinoneimine dyes and methine dyes (described in Japanese Patent Provisional Publication Nos. 58(1983)-173696, 58(1983)-181690 and 58(1983)-194595).

The IR absorbing dye is also described in U.S. Pat. Nos. 4,756,993, 5,156,938 and Japanese Patent Provisional Publication Nos. 10(1998)-268512, 2004-306582. Commercially available IR absorbing dyes (e.g., Epolight III-178, III-130, III-125, from EPOLINE) are also usable.

The agent capable of converting light to heat can be contained in microcapsules. The amount of the agent is preferably in the range of 0.001 to 50 wt. %, more preferably in the range of 0.005 to 30 wt. %, most preferably in the range of 0.01 to 10 wt. % based on the total solid content of the hydrophilic image-recording layer.

[Polymerization Initiator]

For polymerizing the polymerizable compound, a polymerization initiator can be used.

The polymerization initiator generates radicals when receiving energy of heat and/or light, and thereby starts and accelerates polymerization of the compound having polymerizable unsaturated groups. The polymerization initiator can be optionally selected from known thermal polymerization initiators and compounds containing chemical bonds of small dissociation energy.

Preferred is a compound generating radicals when receiving thermal energy (namely, thermal radial generator). The thermal radial generator can be optionally selected from known thermal polymerization initiators and compounds containing chemical bonds of small dissociation energy.

Two or more compounds generating radicals can be use in combination. The compounds generating radicals are described in Japanese Patent Provisional Publication No. 2004-306582. Examples of the radical-generating compounds include halogenated organic compounds, carbonyl compounds, organic peroxides, azo polymerization initiators, azide compounds, metallocene compounds, hexaarylbiimidazole compounds, organic boric compounds, disulfonic compounds, oxime ester compounds and oxime compounds. Preferred are onium salts.

[Support]

The hydrophilic support can be a sheet or plate of paper, polymer (e.g., cellulose ester, polyester, polyethylene, polystyrene, polypropylene, polycarbonate, polyvinyl acetal), metal (e.g., aluminum, zinc, copper), paper laminated with polymer, metal-deposited paper, or metal-deposited polymer. Preferred are a polymer film and a metal plate, more preferred are a polyester film or an aluminum plate, and most preferred is an aluminum plate.

The aluminum plate is a plate of pure aluminum or an alloy plate comprising the main component of aluminum and a little amount of other metals. Examples of the metals other than aluminum include Si, Fe, Mn, Mg, Cu, Cr, Zn, Bi, Ni and Ti. The amount of those metals is preferably 10 wt. % or less.

The aluminum plate has a thickness of preferably 0.1 to 0.8 mm, more preferably 0.15 to 0.6 mm, most preferably 0.2 to 0.4 mm.

The surface of the aluminum plate is preferably subjected to roughing treatment. For example, the surface can be mechanically roughed by sand-blast grinding or brush grinding to make small concaves.

Before the roughing treatment, the surface can be subjected to degreasing treatment so as to remove rolling oil attached thereon. The degreasing treatment can be carried out with a surface active agent, an organic solvent or an alkaline aqueous solution.

The roughing treatment can be mechanically, electrochemically or chemically carried out. Examples of the mechanical roughing treatment include ball grinding, brush grinding, blast grinding and buff grinding.

The electrochemical roughing treatment is, for example, a procedure in which direct or alternative current is applied to the plate in an electrolysis solution containing acid (such as hydrochloric acid or nitric acid). The electrolytic roughing in a mixed acid (described in Japanese Patent Provisional Publication No. 54(1979)-63902) may be carried out.

While the aluminum plate is subjected to the rolling treatment, convexes and concaves can be form on the surface with a pressing roll having convexes and concaves. The convexes and concaves of the roll can be transferred onto the surface by mechanical embossing process. Further, the surface may be roughed by gravure printing, or otherwise a layer containing solid fine particles (matting agent) may be formed by coating or by printing to rough the support surface. In that case, when a polymer film for the support is produced, the solid fine particles can be incorporated therein to roughen the surface of the film. The roughing treatment can be also carried out by solvent treatment, corona discharge treatment, plasma discharge treatment, electron beam exposure, X-ray exposure or combination thereof. Particularly preferred are sand-blast grinding, printing of resin and addition of solid fine particles.

After the roughing treatment, the aluminum plate is preferably subjected to alkali etching treatment and further neutralizing treatment.

The aluminum plate is preferably subjected to anodic oxidation treatment.

Various electrolytes forming a porous oxide film can be used in the anodic oxidation treatment. Examples of the electrolyte include sulfuric acid, hydrochloric acid, oxalic acid, chromic acid, and mixtures thereof. The concentration of the acid is optionally selected.

The anodic oxidation treatment is generally carried out under the following conditions: the concentration of the electrolytic solution is in the range of 1 to 80 wt. %, the temperature of the solution is in the range of 5 to 70° C., the electric current density is in the range of 5 to 60 A/dm², the voltage is in the range of 1 to 100 V, and the time for electrolysis is in the range of 10 seconds to 5 minutes. The oxide film formed by the anodic oxidation has a thickness of preferably 1.0 to 5.0 g/m², more preferably 1.5 to 4.0 g/m².

[Other Layers]

Between the support and the hydrophilic layer, an undercoating layer can be provided. Further, a protective layer can be formed on the hydrophilic image-recording layer.

[Presensitized Lithographic Plate]

In the embodiment comprising a hydrophilic image-recording layer, the presensitized lithographic plate comprising the hydrophilic image-recording layer and the support is used to print.

In the printing procedure of this embodiment, first the presensitized lithographic plate composed of the support and the hydrophilic image-recording layer is treated to convert a part of the hydrophilic image-recording layer into a hydrophobic layer imagewise in accordance with an image to be recorded and thereby to form a lithographic printing plate which comprises an imaging layer having a hydrophilic area and a hydrophobic area. After that, printing is carried out with the formed printing plate while dampening water and oily ink are being supplied to the plate so that 0.1 to 2 g/m² of the dampening water can keep attaching onto the hydrophilic area and that the oily ink can keep attaching onto the hydrophobic area.

In the embodiment where the hydrophilic substrate comprising the support and the hydrophilic layer is used, an image-recording layer is provided on the hydrophilic layer to produce the presensitized lithographic plate.

The image-recording layer is a layer of posi-type (which becomes soluble in an alkaline aqueous solution when exposed to light) or a layer of nega-type (which becomes insoluble in an alkaline aqueous solution when exposed to light). Both layers are known. If the exposed or unexposed area of the image-recording layer can be removed with the dampening water or the oily ink, the normal developing treatment (in which the exposed or unexposed area is removed) can be omitted and, immediately after exposure, the plate can be directly installed on the press to print. That image-recording layer is already known.

In the printing procedure of this embodiment, first the presensitized lithographic plate composed of a hydrophilic substrate comprising the support and the hydrophilic layer and of an image-recording layer provided on the hydrophilic layer is treated to remove a part of the image-recording layer imagewise in accordance with an image to be recorded and thereby to form a lithographic printing plate which comprises a hydrophilic area corresponding to the bared hydrophilic layer and a hydrophobic area corresponding to the remaining image-recording layer. After that, printing is carried out with the formed printing plate while dampening water and oily ink are being supplied to the plate so that 0.1 to 2 g/m² of the dampening water can keep attaching onto the hydrophilic area and that the oily ink can keep attaching onto the hydrophobic area.

The image-recording layer provided on the hydrophilic layer can contain a compound (preferably, a polymer) in which hydrophilic properties change into hydrophobic properties when exposed to heat or otherwise a hydrophobic compound in the form of thermoplastic particles, thermosetting particles or microcapsules. The above description of the hydrophilic-hydrophobic properties converting agent contained in the hydrophilic image-recording layer can be also applied to them.

The image-recording layer can contain an agent capable of converting light to heat and/or a polymerization initiator. The above description of the light-heat converting agent and the polymerization initiator contained in the hydrophilic image-recording layer can be also applied to them.

The hydrophobic area can be directly formed on the hydrophilic layer (for example, by ink-jetting hydrophobic oil-drops imagewise onto the layer or by forming an image of hydrophobic toner according to electrophotography), to prepare the printing plate.

In the printing procedure of this embodiment, first a hydrophobic material is attached onto a hydrophilic substrate comprising a support and a hydrophilic layer imagewise in accordance with an image to be recorded and thereby to form a lithographic printing plate which comprises a hydrophilic area where the hydrophobic material is not attached and a hydrophobic area where the hydrophobic material is attached. After that, printing is carried out with the formed printing plate while dampening water and oily ink are being supplied to the plate so that 0.1 to 2 g/m² of the dampening water can keep attaching onto the hydrophilic area and that the oily ink can keep attaching onto the hydrophobic area.

[Measurement of Water Content]

(Amount of Water Staying on Hydrophilic Area in Printing)

The titled amount is measured by means of an infrared water-analyzer (according to DMS: documentation of molecular spectroscopy), by which an infrared absorption spectrum is obtained. The absorption intensity at 3,378 cm⁻¹, which is attributed to O—H stretching vibration of water molecule, in the obtained spectrum is measured to evaluate the amount of water. The measurement according to DMS is essentially based on the infrared absorption intensity. In order to evaluate the amount of water from the absorption intensity, it is necessary to draw a working curve. For obtaining the working curve, water is supplied to a dried sample and the water content is evaluated from the change of weight. At the same time, the infrared absorption intensity is measured, and thereby the correlation between the water content and the absorption intensity is obtained.

(Amount of Water Contained in the Hydrophilic Layer)

After left for 1 hour at the temperature of 25° C. and the humidity of 10%, a sample is weighed to determine the dry weight (A1). The sample is then placed on a metal plate having the dew-point temperature of 23° C. and left at the temperature of 25° C. and the humidity of 90% so as to absorb moisture sufficiently. The thus-treated sample is weighed to determine the weight (A2), and the difference of (A2)-(A1) is calculated to evaluate the titled amount.

### EXAMPLE 1

(Preparation of Aluminum Support)

A surface of an aluminum plate (material: 1050) having the thickness of 0.24 mm was ground with a nylon brush and an aqueous suspension of pumice stone of 400 mesh, and the plate was then well washed with water. The aluminum plate was then immersed for etching in 15% aqueous solution of sodium hydroxide, and washed with water. After neutralized with 1% nitric acid, the plate was subjected to electrolytic surface-roughening treatment in 0.7% aqueous solution of nitric acid in an anodically electric amount of 160 coulomb/dm² using sine wave alternating-corrugated current. The plate was washed with water, and again immersed for etching in 10% aqueous solution of sodium hydroxide and further washed with water. The plate was then immersed for matting in 30 wt. % aqueous solution of sulfuric acid, and washed with water. Further, the plate was subjected to anodizing treatment in 20 wt. % aqueous solution of sulfuric acid, to form an anodic oxide layer having the thickness of 2.7 g/m². The plate was then treated with 0.5 wt. % aqueous solution of sodium silicate at 30° C. for 10 seconds, to obtain an aluminum support. The average roughness of the thus-treated aluminum plate was 0.45 μm.

(Formation of Undercoating Layer)

The following coating solution was prepared and spread in the amount of 0.5 g/m² to coat the above aluminum support, and dried at 100° C. for 1 minute to form an undercoating layer.

Coating solution for undercoating layer

| | | |
|---|---|---|
| Methanol silica (30 wt. % methanol dispersion, Nissan | 400 | g |
| Chemical Co., Ltd.) | | |
| Isopropyl alcohol | 2,000 | g |

(Preparation of So-Gel Liquid)

Into a mixture of 2,000 g of ethyl alcohol, 100 g of acetylacetone, 100 g of tetraethyl orthotitanate and 1,000 g of purified water, 100 g of tetramethoxysilene (Tokyo Chemical Industry Co., Ltd.) and 35 g of the following hydrophilic polymer (1) in which a functional group corresponding to silane-coupling agent is contained at the terminal were mixed and stirred at 60° C. for 4 hours. The prepared mixture was gradually cooled to room temperature, to obtain a sol-gel liquid. 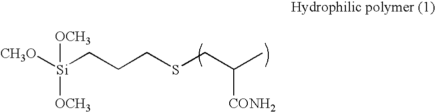
(Formation of Hydrophilic Layer)

The following coating solution was prepared and spread to coat the undercoating layer by means of a bar-coater, so that the resultant layer after dried might be in the amount of 1.0 g/m². The spread solution was then dried in an oven at 80° C. for 10 minutes, to form a hydrophilic layer. Thus, a hydrophilic substrate was produced.

Coating solution for hydrophilic layer

| | | |
|---|---|---|
| Colloidal silica (20 wt. % aqueous solution, Snowtex C, | 70 | g |
| Nissan Chemical Co., Ltd) | | |
| Sol-gel liquid | 500 | g |
| Anionic surface active agent (5 wt. % aqueous solution, | | |
| NIKKOL OTP-100S, Nikko Chemicals Co., Ltd.) | 30 | g |
| Purified water | 400 | g |

### EXAMPLE 2

The following coating solution was prepared and spread to coat an aluminum support produced in Example 1 by means of a bar-coater, and then dried in an oven at 140° C. for 10 minutes to form a hydrophilic layer of 1.0 g/m². Thus, a hydrophilic substrate was produced.

Coating solution for hydrophilic layer

| | |
|---|---|
| Water | 2,500 g |
| Polyacrylic acid (weight average molecular weight: | 20 g |
| 100,000) | |
| The following hydrophilic polymer (2) having a reac- | 60 g |
| tive group at one of the terminals | |
| The following cross-linking agent (1) | 25 g |
| Colloidal silica (20 wt. % aqueous solution, Snowtex C, | 1,200 g |
| Nissan Chemical Co., Ltd) | |
| Surface active agent (5 wt. % aqueous solution of di- | 20 g |
| ethylhexyl sulfosuccinate sodium salt) | |

Hydrophilic polymer (2)

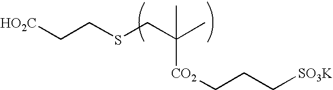

Cross-linking agent (1)

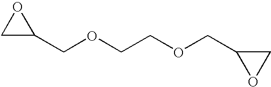

### EXAMPLE 3

The following coating solution was prepared and spread to coat an aluminum support produced in Example 1 by means of a bar-coater, and then dried in an oven at 140° C. for 10 minutes to form a hydrophilic layer of 1.0 g/m². Thus, a hydrophilic substrate was produced.

Coating solution for hydrophilic layer

| | | |
|---|---|---|
| Water | 2,500 | g |
| Polyacrylic acid (weight average molecular weight: | 10 | g |
| 250,000) | | |
| Methanol silica (30 wt. % methanol dispersion, Nissan | 300 | g |
| Chemical Co., Ltd.) | | |
| Surface active agent (5 wt. % aqueous solution of | 20 | g |
| diethylhexyl sulfosuccinate sodium salt) | | |

### EXAMPLE 4

(Formation of Undercoating Layer)

The following coating solution was prepared and spread in the amount of 2 g/m² to coat an aluminum support produced in Example 1, and dried at 100° C. for 1 minute to form an undercoating layer.

Coating solution for undercoating layer

| | |
|---|---|
| The following polymer (3) | 16 g |
| The following polymerization initiator (1) | 4 g |
| Methyl ethyl ketone | 500 g |
| 1-Methoxy-2-propanol | 500 g |

Polymer (3)

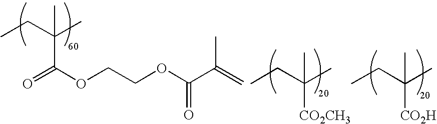

Polymerization initiator (1)

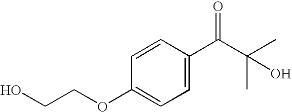

(Formation of Hydrophilic Layer)

The following aqueous solution was prepared, and then the aluminum support coated with the undercoating layer was immersed therein. The thus-treated support was irradiated with a low-pressure mercury lamp of 100 W for 10 minutes in an atmosphere of nitrogen gas, to form a hydrophilic layer of graft polymer (thickness: 0.2 μm) on the undercoating layer. Thus, a hydrophilic substrate was produced.

Aqueous solution for hydrophilic layer

| | |
|---|---|
| Acrylic acid | 100 g |
| Purified water | 900 g |

### EXAMPLE 5

The procedure of Example 4 was repeated except that the acrylic acid in the aqueous solution was replaced with acrylamide, to produce a hydrophilic substrate.

### EXAMPLE 6

The procedure of Example 4 was repeated except that the acrylic acid in the aqueous solution was replaced with potassium salt of sulfopropyl methacrylate, to produce a hydrophilic substrate.

### EXAMPLE 7

The procedure of Example 1 was repeated except that the aluminum support was replaced with a polyethylene terephthalate film (thickness: 0.24 mm) having been subjected to the corona discharge surface treatment, to produce a hydrophilic substrate.

(Measurement of Water Content in Printing)

Each hydrophilic substrate produced in Examples 1 to 7 was set on a cylinder of sheet-feed press (DAIYA 1F-2, Mitsubishi Heavy Industries, Ltd.). At the position of 4 mm apart from the substrate face, a sensor comprising the light-emitter and the light-receiver of infrared water-analyzer (DMS) was placed. After water and ink were supplied, printing was started. While the printing was continued at the rate of 7,200 rotation/hour, the amount of water staying on the surface was measured after approx. 100 sheets were printed.

The results are set forth in Table 1.

(Measurement of Water Content in the Hydrophilic Layer)

After left for 1 hour at the temperature of 25° C. and the humidity of 10%, each hydrophilic substrate produced in Examples 1 to 7 was weighed to determine the dry weight (A1). The substrate was then placed on a metal plate having the dew-point temperature of 23° C. and left at the temperature of 25° C. and the humidity of 90% so as to absorb moisture sufficiently. The thus-treated sample was weighed to determine the weight (A2), and the difference of (A2)(A1) is calculated to evaluate the titled amount. The results were set forth in Table 1.

(Evaluation of Stainless Image))

On the obtained support of lithographic printing plate, a solid image was drawn with a felt-tip marker of organic ink. The support was then set on a cylinder of sheet-feed press (DAIYA 1F-2, Mitsubishi Heavy Industries, Ltd.). Dampening water (mixture of etching solution (EU-3, Fuji Photo Film Co., Ltd.)/water/isopropyl alcohol=1/89/10 by volume) and black ink (TRANS-G(N), Dainippon Ink & Chemicals Inc.) were supplied, and then printing was started at the rate of 7,200 rotation/hour. After approx. 100 sheets were printed, the amount of supplied water was controlled to evaluate the balance between the water and the ink and thereby to determine how much water was supplied when stain (or scum) was first observed. The amount of supplied water was measured by means of a gauge installed in the press, and hence was represented in terms of numbers indicated by the gauge. The smaller the indicated numbers is, the better in hydrophilicity and in anti-stain the support is. Independently, after the ink was spread on the whole surface of the plate, the printing was carried out with the dampening water supplied. The printing was continued until the ink was completely cleared from the surface, to determine how many sheets were printed. The fewer the sheets mean an excellently hydrophilic support that scarcely causes stain.

The results are set forth in Table 1.

TABLE 1

| | Water | Water | | | Number |
|---|---|---|---|---|---|
| | content in | content in | | Numbers | of |
| Hydrophilic | printing | hydrophilic | (A) − (B) | indicated | printed |
| substrate | (A) | layer (B) | (g/m²) | by gauge | papers |
| Example 1 | 0.40 g/m² | 0.30 g/m² | 0.10 | 35 | 15 |
| Example 2 | 0.60 g/m² | 6.50 g/m² | 0.10 | 35 | 20 |
| Example 3 | 0.70 g/m² | 0.55 g/m² | 0.15 | 40 | 20 |
| Example 4 | 1.00 g/m² | 0.70 g/m² | 0.30 | 35 | 25 |
| Example 5 | 1.10 g/m² | 0.75 g/m² | 0.35 | 35 | 20 |
| Example 6 | 1.40 g/m² | 0.50 g/m² | 0.90 | 30 | 20 |
| Example 7 | 0.35 g/m² | 0.25 g/m² | 0.10 | 35 | 20 |

### EXAMPLES 8 TO 14

The following photosensitive solution was prepared.

Photosensitive solution (1)

| | |
|---|---|
| The following binder polymer (4) | 16 g |
| The following polymerization initiator (2) | 10 g |
| The following IR absorber (1) | 2 g |
| Polymerizable monomer (Aronics M-215, TOAGOSEI Co., | 40 g |
| Ltd.) | |
| The following fluorocarbon surface active agent (1) | 4 g |
| Methyl ethyl ketone | 110 g |
| MFG | 860 g |

Binder polymer (4)

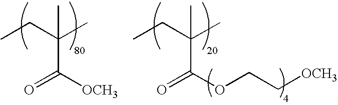

Polymerization initiator (2)

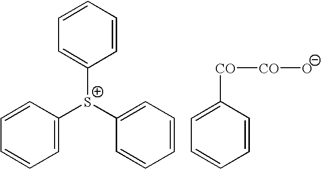

IR absorber (1)

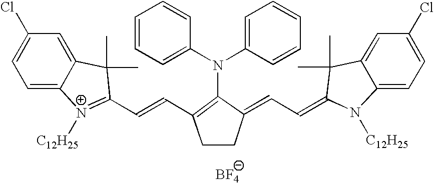

Fluorocarbon surface active agent (1)

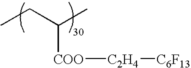

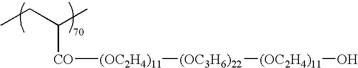

(Preparation of Microcapsule Dispersion)

In 16.67 g of ethyl acetate, 10 g of an adduct of trimethylolpropane and xyleneisocyanate (75% ethyl acetate solution of Takenate D-110N, Mitsui Takeda Chemicals, Inc.), 6.00 g of ethylenically unsaturated monomer (Aronics M-215, Toagosei Co., Ltd.) and 0.12 g of a surface active agent (Pionine A-41C, Takemoto Oil & Fat) were dissolved to prepare an oily phase.

Independently, 37.5 g of 4 wt. % aqueous solution of polyvinyl alcohol (PVA-205, Kuraray Co., Ltd.) was prepared as an aqueous phase.

The oily phase and the aqueous phase were mixed and emulsified by means of a homogenizer at 12,000 rpm for 10 minutes. To the obtained emulsion, 25 g of distilled water was added. The mixture was stirred at room temperature for 30 minutes, and then further stirred at 40° C. for 2 hours. The obtained dispersion was diluted with water so that the solid content might be 15 wt. %. The mean size of the formed microcapsules was 0.2 μm.

(Preparation of Microcapsule Liquid)

The following microcapsule liquid was prepared.

Microcapsule liquid

| | |
|---|---|
| The above microcapsule dispersion | 260 g |
| Water | 240 g |

(Formation of Image-Recording Layer)

The photosensitive solution and the microcapsule liquid were mixed and stirred to prepare a coating solution for image-recording layer.

Immediately after prepared, the coating solution was spread to coat each hydrophilic substrate of Examples 1 to 7 by means of a bar-coater, and then dried in an oven at 100° C. for 60 seconds to form an image-recording layer of 1.0 g/m².

(Preparation of Inorganic Particle Dispersion)

In 193.6 g of ion-exchanged water, 6.4 g of synthesized mica (Somasif ME-100, Co-op Chemical Co., Ltd.) was added. The mixture was kept stirred by means of a homogenizer until the dispersed mica particles had the mean size of 3 μm (which was confirmed according to the laser scattering method). The dispersed mica particles had aspect ratios of 100 or more.

(Production of Press-Developing Type Presensitized Lithographic Plate)

The following coating solution for protective layer was prepared and spread to coat the image-recording layer by means of a bar-coater, and dried at 120° C. for 60 seconds to form a protective layer in the amount of 0.15 g/m².

Thus, a press-developing type presensitized lithographic plate was produced.

Coating solution for protective layer

| | | |
|---|---|---|
| The inorganic particle dispersion | 150 | g |
| Polyvinyl alcohol (PVA-105, Kuraray Co., Ltd.; saponi- | 6 | g |
| fication degree: 98.5 mol. %, polymerization degree: 500) | | |
| Polyvinyl pyrrolidone (K30, Tokyo Chemical Industry Co., | 1 | g |
| Ltd.; weight average molecular weight: 40,000) | | |
| Copolymer of vinyl pyrrolidone/vinyl acetate (LUVITEC | 1 | g |
| VA64W, ICP; copolymerization ratio: 6/4) | | |
| Nonionic surface active agent (Emalex 710, Nihon | 1 | g |
| Emulsion Co., Ltd.) | | |
| Ion-exchanged water | 600 | g |

(Evaluation of Printing)

The above-produced presensitized lithographic plate was exposed through a thin-lined chart to infrared light emitted from a water-cooled 40 w infrared laser installed in Trendsetter 3244VX (Creo, power: 9 W, rotation of outer drum: 210 rpm, resolution: 2,400 dpi). The thus-exposed plate was not subjected to the normal developing treatment, but directly set on a cylinder of press (SOR-M, Heidelberg). After dampening water [mixture of etching solution (EU-3, Fuji Photo Film Co., Ltd.)/water/isopropyl alcohol=1/89/10 by volume] and black ink (TRANS-G(N), Dainippon Ink & Chemicals Inc.) were supplied, 1,000 sheets were printed at the rate of 6,000 rotation/hour.

It was counted how many sheets had been printed until the image-recording layer in the unexposed area was so developed on the press that ink was not transferred to the sheet, and thereby the performance of press development was evaluated. As a result, each presensitized plate gave 1,000 sheets without unfavorable stain on the non-imaging area.

### EXAMPLE 15

(Production of Non-Developing Type Presensitized Lithographic Plate)

The microcapsules (1) prepared in Example 7 were added into the coating solution (1) for hydrophilic layer in Example 1 in the amount of 50 wt. % (in terms of solid content) based on the total solid content. The obtained liquid was spread to coat the undercoating layer in the same manner as in Example 1, and dried to form a hydro-philic image-recording layer. Thus, a non-developing type presensitized lithographic plate was produced.

(Evaluation of Printing)

The produced presensitized plate was imagewise exposed in the same manner as in Examples 8 to 14, and then not subjected to any treatment but set on the press. After the dampening water and the ink were supplied, 1,000 sheets were printed at the rate of 6,000 rotation/hour. As a result, the plate gave 1,000 sheets without unfavorable stain on the non-imaging area.

### EXAMPLES 16 TO 21

(Preparation of Resin Particles)

A mixture of 14 g of poly(dodecyl methacrylate), 100 g of vinyl acetate, 4.0 g of octadecyl methacrylate and 286 g of ISOPAR H was stirred and heated in an atmosphere of nitrogen gas to 70° C. To the heated mixture, 1.5 g of 2,2′-azobis(isovaleronitrile) [polymerization initiator] was added and allowed to react for 4 hours. Further, after 0.8 g of 2,2′-azobis(isobutylonitrile) was added, the reaction liquid was heated to 80° C. and allowed to react for 2 hours. Successively, 0.6 g of 2,2′-azobis(isobutylo-nitrile) was added and allowed to react for 2 hours. The reaction liquid was then heated to 100° C., and stirred for 1 hour to distill off unreacted monomer. After cooled, the liquid was filtrated through nylon cloth of 200 mesh, to obtain a white dispersion. The dispersion was latex having the polymerization ratio of 93% and the mean particle size of 0.35 μm, which was determined by means of CAPA-500 (Horiba, Ltd.).

(Preparation of Oily Ink)

In a paint-shaker (Toyo Seiki Seisaku-sho, Ltd.), 10 g of dodecyl methacrylate/acrylic acid copolymer (copolymerization ratio: 98/2 by weight), 10 g of Alkali Blue, 30 g of Shell sol 71 and glass beads were placed and mixed for 4 hours to obtain a blue dispersion of fine Alkali Blue particles.

After that, 50 g (solid content) of the above resin particles, 5 g (solid content) of the obtained blue dispersion and 0.06 g of zirconium naphthenate were mixed and added to 1 liter of ISOPAR G, to prepare blue oily ink.

(Production of Presensitized Lithographic Plate by Ink Jet)

A plotter (Servo plotter DA8400, Graphtec America Inc.), by which an image was outputted from a personal computer, was modified, so that the plotting pen was replaced with an inkjet nozzle. Each hydrophilic substrate of Examples 1 to 6 was placed on a counter electrode placed at the position of 1.5 mm apart from the nozzle. Onto the thus-placed substrate, the oily ink was jetted out to draw an image for producing a plate. In the process, the aluminum back surface of the support and the counter electrode were electrically connected with silver paste.

The thus-processed plate was heated for 10 seconds with a Ricoh fuser (Ricoh Co., Ltd.) so that the temperature of the plate surface might be 70° C., to fix the image drawn in the ink. The image was then observed through an optical microscope (×200). As a result, each obtained image was found to be very clear and to have neither blurs nor defects even at thin lines.

(Evaluation of Printing)

The printing performance of the produced presensitized plate was evaluated in the above manner for plates of Examples 8 to 14. As a result, the plate gave 1,000 sheets without unfavorable stain on the non-imaging area.

1. A lithographic printing plate which comprises a support and an imaging layer consisting of a hydrophilic area on which dampening water is attached and a hydrophobic area on which oily ink is attached, wherein the dampening water is attached on the hydrophilic area in an amount of 0.1 to 2 g/m².

2. The lithographic printing plate as defined in claim 1, wherein the imaging layer is provided on the support in an amount of 0.1 to 10 g/m².

3. The lithographic printing plate as defined in claim 1, wherein the imaging layer absorbs and retains the dampening water in an amount of 0.01 to 2 g/m².

4. The lithographic printing plate as defined in claim 1, wherein the imaging layer comprises a hydrophilic layer and a hydrophobic layer imagewise formed on the hydrophilic layer.

5. The lithographic printing plate as defined in claim 1, wherein the imaging layer is a layer formed by imagewise converting a hydrophilic layer into a hydrophobic layer.

6. The lithographic printing plate as defined in claim 1, wherein the imaging layer contains a cross-linked hydrophilic polymer formed by reaction of a hydrophilic polymer with a cross-linking agent, said cross-linking reactive agent having cross-linking groups in an amount of 10 to 100 mole % based on cross-linking reactive groups contained in said hydrophilic polymer.

7. The lithographic printing plate as defined in claim 1, wherein the imaging layer contains a cross-linked hydrophilic polymer formed by reaction of cross-likable hydrophilic polymers having cross-linking groups, and wherein the cross-linking groups remain in the cross-linked polymer in an amount of 0 to 80 mole %.

8. The lithographic printing plate as defined in claim 1, wherein the imaging layer contains a graft-copolymerized hydrophilic polymer.

9. The lithographic printing plate as defined in claim 1, wherein the imaging layer contains particle filler in an amount of 5 to 70 wt. % based on the solid content of the imaging layer.

10. A presensitized lithographic plate comprising a support and a hydrophilic image-recording layer convertible into a hydrophobic layer, wherein the hydrophilic image-recording layer has a function of absorbing and retaining water in an amount of 0.01 to 2 g/m².

11. A lithographic hydrophilic substrate comprising a support and a hydrophilic layer, wherein the hydrophilic layer has a function of absorbing and retaining water in an amount of 0.01 to 2 g/m².

12. A lithographic printing method comprising the steps of: subjecting a presensitized lithographic plate comprising a support and a hydrophilic image-recording layer to a process of imagewise converting the hydrophilic image-recording layer into a hydrophobic layer to form a lithographic printing plate which comprises an imaging layer consisting of a hydrophilic area and a hydrophobic area; and then printing with the lithographic printing plate while supplying dampening water and oily ink to the plate under the condition that the dampening water is attached on the hydrophilic area in an amount of 0.1 to 2 g/m² and the oily ink is attached on the hydrophobic area.

13. A lithographic printing method comprising the steps of: subjecting a presensitized lithographic plate comprising a hydrophilic substrate and an image-recording layer, said substrate comprising a support and a hydrophilic layer to a process of imagewise removing the image-recording layer to form a lithographic printing plate which comprises a hydrophilic area corresponding to the exposed hydrophilic layer and a hydrophobic area corresponding to the remaining image-recording layer; and then printing with the lithographic printing plate while supplying dampening water and oily ink to the plate under the condition that the dampening water is attached on the hydrophilic area in an amount of 0.1 to 2 g/m² and the oily ink is attached on the hydrophobic area.

14. A lithographic printing method comprising the steps of: imagewise attaching a hydrophobic material onto a hydrophilic substrate comprising a support and a hydrophilic layer to form a lithographic printing plate which comprises a hydrophilic area where the hydrophobic material is not attached and a hydrophobic area where the hydrophobic material is attached; and then printing with the lithographic printing plate while supplying dampening water and oily ink to the plate under the condition that the dampening water is attached on the hydrophilic area in an amount of 0.1 to 2 g/m² and the oily ink is attached on the hydrophobic area.
